(19) United States
(12) Patent Application Publication
(10) Pub. No.: US 2007/0130376 A1
(43) Pub. Date: Jun. 7, 2007

(54) Method and apparatus for setting configuration information

(75) Inventor: Chong-ho Moon, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/594,198

(22) Filed: Nov. 8, 2006

(30) Foreign Application Priority Data
Dec. 2, 2005 (KR) 10-2005-0116885
Jun. 19, 2006 (KR) 10-2006-0054915

(51) Int. Cl. G06F 3/00

(52) U.S. Cl. 710/8

(57) ABSTRACT

A method and apparatus for changing configuration information by using configuration information comparison is provided. The method includes displaying comparison configuration information reflecting current configuration information and previous configuration information, and changing the current configuration information by referring to the comparison configuration information. Accordingly, when complicated configuration information of an electronic device is confirmed or changed, the configuration information can be confirmed or changed with a simple operation.

### CROSS-REFERENCE TO RELATED PATENT APPLICATION

This application claims the benefit under 35 U.S.C. § 119(a) of Korean Patent Application No. 10-2005-0116885, filed on Dec. 2, 2005, in the Korean Intellectual Property Office, and the benefit of Korean Patent Application No. 10-2006-0054915, filed on Jun. 19, 2006, in the Korean Intellectual Property Office, the entire disclosures of which are hereby incorporated by reference.

### BACKGROUND OF THE INVENTION

1. Field of the Invention

The present invention relates to confirmation or change of configuration information for a user interface apparatus used in electronic devices such as printers and multifunction peripherals (MFPs). More particularly, the present invention relates to a method and apparatus for confirming previous configuration information and recently changed configuration information without a separate operation when a plurality of tabs of configuration information exist or when changed configuration information is confirmed.

2. Description of the Related Art

Recently, the user interfaces of electronic devices such as printers and multifunction peripherals (MFPs) have become more complicated as the various functions of the electronic devices have become more complicated.

For example, for a printer, a large amount of configuration information must be changed according to the kind of printed matter. In some cases, to change the configuration information, several key operations are required to confirm previous configuration information and current configuration information.

In general, a conventional user interface apparatus includes features such as a user interface window, a main window, tabs, an OK button, a pop-up window, and a sub window. A user interface window is a window displayed by an apparatus to communicate with a user, a main window is a window displaying the contents of a selected tab, a tab is an icon in the main window for selecting which main window is displayed, an OK button is a button for storing configuration information, a pop-up window is a window for displaying configuration information dependent upon a selected button when the button is selected in the main window, and a sub-window is a window that represents functions of tabs in a pop-up window.

Typically, to confirm or change configuration information in a user interface apparatus, a user searches for a desired function hierarchically. For example, when a user wants to adjust color intensity, the user can adjust configuration information regarding color adjustment by opening the user interface window, selecting a graphics tab, pressing a color adjust button, and selecting a setting tab in the pop-up window. That is, to confirm or change configuration information in a conventional user interface apparatus, the user must perform complicated key operations. In addition, a method of checking the history of changes in the configuration information and re-setting the configuration information according to previously set specific configuration information has not been suggested.

Accordingly, there is a need for an improved user interface for setting configuration information in a simple manner.

### SUMMARY OF THE INVENTION

An aspect of the present invention is to address at least the above problems and/or disadvantages and to provide at least the advantages described below. Accordingly, an aspect of the present invention is to provide a user interface method and apparatus using configuration information comparison to allow a user to confirm or change configuration information with a simple operation.

According to an aspect of the present invention, a method of setting configuration information is provided. The method comprises displaying comparison configuration information that reflects a comparison of current configuration information and previous configuration information, and changing the current configuration information by referring to the comparison configuration information.

According to another aspect of the present invention, an apparatus for setting configuration information is provided. The apparatus comprises a display unit that displays comparison configuration information that reflects current configuration information and previous configuration information, and a configuration information change unit that changes the current configuration information by referring to the comparison configuration information.

According to another aspect of the present invention, a method of setting configuration information is provided. The method comprises managing change history information regarding a history of changes to configuration information, and displaying the change history information when an event occurs.

According to another aspect of the present invention, an apparatus for setting configuration information is provided. The apparatus comprises a change history information management unit that manages change history information regarding changes to configuration information, a memory unit that stores the change history information, and a display unit that reads the change history information from the memory unit when an event occurs and displays the read change history information.

### BRIEF DESCRIPTION OF THE DRAWINGS

The above and other objects, features, and advantages of certain exemplary embodiments of the present invention will be more apparent from the following description taken in conjunction with the accompanying drawings, in which:

FIG. 1 is a flowchart of a method of changing configuration information according to an exemplary embodiment of the present invention;

FIG. 2 is a flowchart showing operation 10 of FIG. 1 in detail;

FIGS. 3A through 3C are examples of user interface windows to explain operations 30 and 32 of FIG. 2;

FIG. 4 is a block diagram of an apparatus for changing configuration information according to an exemplary embodiment of the present invention;

FIG. 5 is a flowchart of a method of changing configuration information according to another exemplary embodiment of the present invention;

FIG. 6 is an example of a dialog window showing change history information according to the method of FIG. 5;

FIGS. 7A through 7D are examples of dialog windows to explain the operations of the method shown in FIG. 5; and

FIG. 8 is a block diagram of an apparatus for changing configuration information according to another exemplary embodiment of the present invention.

Throughout the drawings, the same reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the embodiments of the invention and are merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

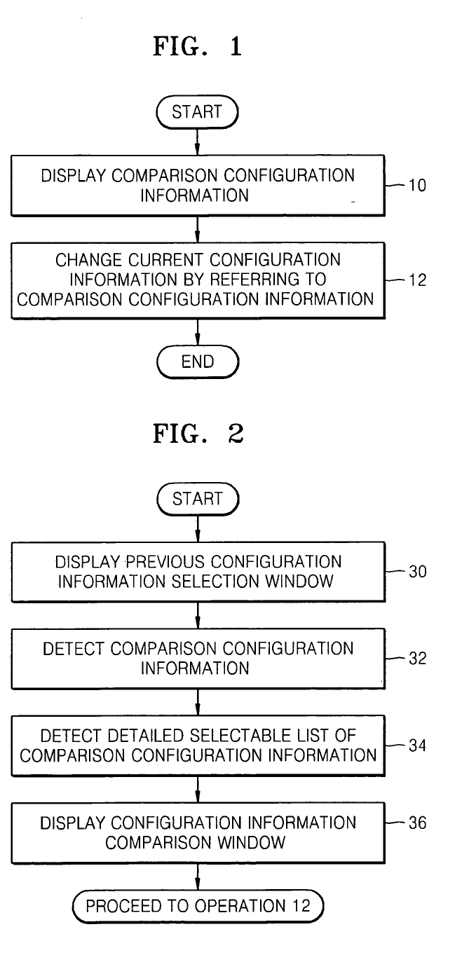

FIG. 1 is a flowchart of a method of changing configuration information by using a comparison of current configuration information and previously configuration information according to an exemplary embodiment of the present invention.

Referring to FIG. 1, in operation 10, comparison configuration information is displayed. Comparison configuration information refers to a comparison of current configuration information with previous configuration information.

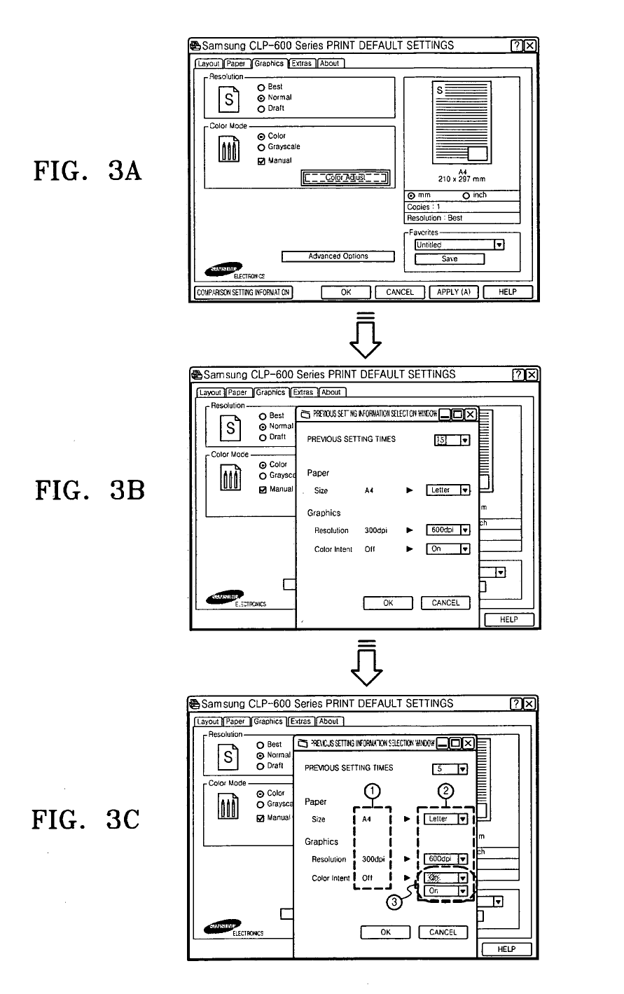

FIG. 2 is a flowchart showing operation 10 of FIG. 1 in detail. FIGS. 3A through 3C are examples of windows to explain operations 30 and 32 of FIG. 2.

Referring to FIGS. 2 and 3, in operation 30, a previous configuration information selection window is displayed to allow a user to select which previously set configuration is compared to the current configuration.

That is, the previous configuration information selection window is a user interface that allows a user to select a previous setting time. The current configuration information is then compared to the configuration information that was in effect at the previous setting time. In other words, any configuration changes made between the previous setting time and the current time are shown in the displayed comparison.

FIG. 3B is an illustration of the previous configuration information selection window. A user inputs the previous setting time in the previous configuration information selection window to select which previous configuration information to use for comparison with the current configuration information. In the illustrated embodiment, the previous setting time is based on the time when the current configuration information was set.

In operation 32, comparison configuration information is generated by comparing the current configuration information and the previous configuration information.

In operation 34, a detailed selectable list of the comparison configuration information is generated. The detailed selectable list of the comparison configuration information indicates selection information, which allows a user to select particular configuration information from the displayed comparison configuration information.

In operation 36, a configuration information comparison window including the comparison configuration information and the detailed selectable list is displayed.

FIG. 3C is an illustration of the configuration information comparison window.

As illustrated in FIG. 3C, the configuration information comparison window displays comparison configuration information. That is, it displays previous configuration information 1 which differs from the current configuration information and current configuration information 2 which differs from the previous configuration information.

In addition, the configuration information comparison window displays a user selectable detailed list 3 in the comparison configuration information.

The configuration information comparison window may be displayed manually, such as by operating a display button or a check mark of a check box, or may automatically pop-up.

For example, as illustrated in FIG. 3A, a user may display the configuration information comparison window by pressing the display button 40.

In addition, a check box to display the configuration information comparison window is included. If the user checks the check box, when the user interface apparatus is inactive, the configuration information comparison window can be displayed. Moreover, when the user interface apparatus is activated, the configuration information comparison window can pop up automatically.

Referring back to FIG. 1, in operation 12, the current configuration information may be changed by referring to the comparison configuration information.

The user can confirm the comparison configuration information displayed in the configuration information comparison window or select a detailed list to be changed. If the user selects the detailed list to be changed, the current configuration information is changed according to the detailed list selected by the user.

The exemplary embodiment of the present invention can be written as code/instructions/computer programs and can be implemented in general-use digital computers that execute the code/instructions/computer programs using a computer readable recording medium. Examples of the computer readable recording medium include magnetic storage media (e.g. ROM, floppy disks, hard disks, etc.), optical recording media (e.g. CD-ROMs, or DVDs), and storage media such as carrier waves (e.g. transmission through the Internet). The computer readable recording medium can also be distributed over network coupled computer systems so that the computer readable code is stored and executed in a distributed fashion. Also, functional programs, code, and code segments for accomplishing the present invention can be easily construed by programmers skilled in the art to which the present invention pertains.

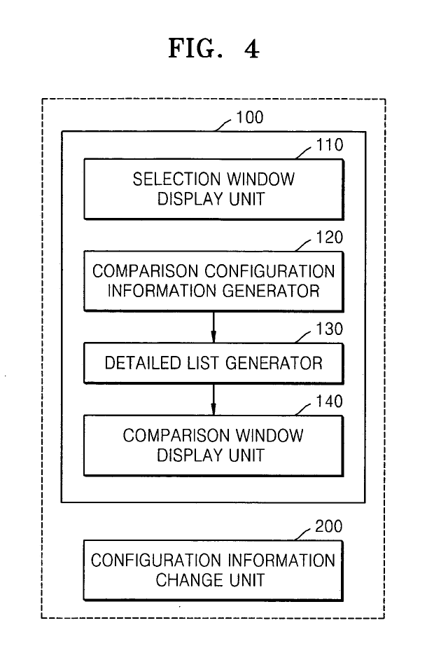

An apparatus for changing configuration information by using configuration information comparison according to an exemplary embodiment of the present invention will now be described in detail with reference to FIG. 4.

FIG. 4 is a block diagram of an apparatus that uses configuration information comparison according to an exemplary embodiment of the present invention. The user interface apparatus of FIG. 4 includes a display unit 100 and a configuration information change unit 200.

The display unit 100 displays comparison configuration information containing current configuration information and previous configuration information.

The display unit 100 includes a selection window display unit 110, a comparison configuration information generator 120, a detailed list generator 130, and a comparison window display unit 140.

The selection window display unit 110 displays a previous configuration information selection window to allow a user to select the previous setting time (before the current configuration information was set) to use for comparison with the current settings.

The previous configuration information selection window is a user interface to select which configuration information previously set based on the time when the current configuration information was set is compared to the current configuration information. The user inputs the previous setting time in the previous configuration information selection window 1 illustrated in FIG. 3B to select the previous configuration information as a comparison subject based on the time when the current configuration information was set.

The comparison configuration information generator 120 generates comparison configuration information reflecting the differences between the previous configuration information selected by the selection window display unit 110 and the current configuration information, and outputs the generated result to the detailed list generator 130. As illustrated in FIG. 3C, the comparison configuration information generator 120 generates comparison configuration information by comparing the current configuration information 2 with the previous configuration information 1.

The detailed list generator 130 generates a detailed selectable list of the comparison configuration information and outputs the result to the comparison window display unit 140. As illustrated in FIG. 3C, the detailed list generator 130 generates a detailed list 3, which the user can use to select among the comparison configuration information.

The comparison window display unit 140 displays a configuration information comparison window including the comparison configuration information and the detailed selectable list. As illustrated in FIG. 3C, the comparison window display unit 140 displays comparison configuration information—that is, previous configuration information 1 which differs from the current configuration information and current configuration information 2 which differs from the previous configuration information in the configuration information comparison window. In addition, the comparison window display unit 140 displays a user selectable detailed list 3 in the configuration information comparison window.

The display unit 100 may display the configuration information comparison window due to the operation of a display button, a check mark of a check box, or may automatically pop-up.

For example, as illustrated in FIG. 3A, a user may press the display button 40 to display the configuration information comparison window.

In addition, a check box to display the configuration information comparison window is included, and if the user checks the check box, when the user interface apparatus is inactive, the display unit 100 can display the configuration information comparison window.

Furthermore, when the user interface is activated, the display unit 100 may make the configuration information comparison window pop up automatically.

The configuration information change unit 200 changes the current configuration information by referring to the comparison configuration information. The user can confirm the comparison configuration information displayed in the configuration information comparison window or select a detailed list to be changed. If the user selects the detailed list to be changed, the configuration information change unit 200 changes the current configuration information according to the detailed list selected by the user.

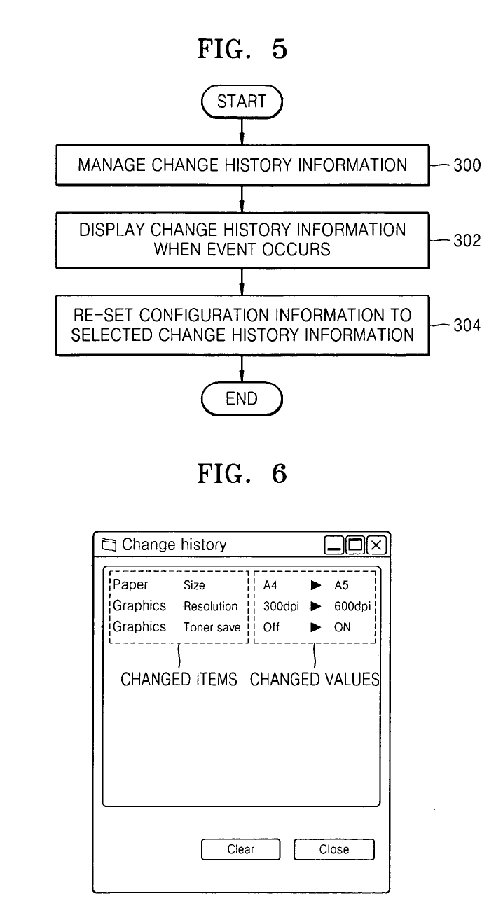

FIG. 5 is a flowchart of a method of changing configuration information by using configuration information comparison according to another exemplary embodiment of the present invention.

Referring to FIG. 5, change history information—that is, a history of changes to configuration information changed from the past to the present—is managed in operation 300. If the configuration information has been changed several times from a certain time in the past to the present, information on each piece of configuration information changed from the past to the present is included in the change history information, and is managed according to the type of change. The change history information is stored in a memory. For example, if the printing image resolution has been changed at a certain time in the past, configuration information regarding the changed resolution is detected and stored. Similarly, if configuration information regarding the size of the printing medium has been changed at a certain time in the past, information regarding the change is managed.

When a specified event occurs, the change history information is displayed in operation 302. A specified event may be, for example, an invocation of a user interface, a change of configuration information, or a request to display change history information. The event ‘invocation of a user interface’ refers to the situation where a user interface is activated for inputting or changing configuration information. When the user interface is activated, the change history information is automatically displayed. The event ‘change of configuration information’ refers to the situation where configuration information is changed through the user interface. When configuration information is changed through the user interface, the change history information is automatically displayed. The event ‘request to display change history information’ refers to the situation where a user requests a display of the change history information for checking the change history information. When a change history information display request is input, the change history information is automatically displayed.

FIG. 6 illustrates an example of a dialog window of the change history information displayed according to the method illustrated in FIG. 5. As illustrated in FIG. 6, the displayed change history information includes information on paper size, image resolution, and toner save mode active/inactive, which have all been changed. If a clear button of FIG. 6 is selected, the change history information is deleted. If a close button of FIG. 6 is selected, the dialog window of the change history information is closed.

The configuration information may be re-set by using the displayed change history information in operation 304. If the user selects one of the displayed changes, the configuration information is re-set using the selected change. For example, when a user desires to re-set configuration information regarding resolution and paper size to resolution and paper size that was set at a certain time of the past, the user may select the displayed configuration information, and the current configuration information is re-set to the configuration information corresponding to the selected, previous configuration information.

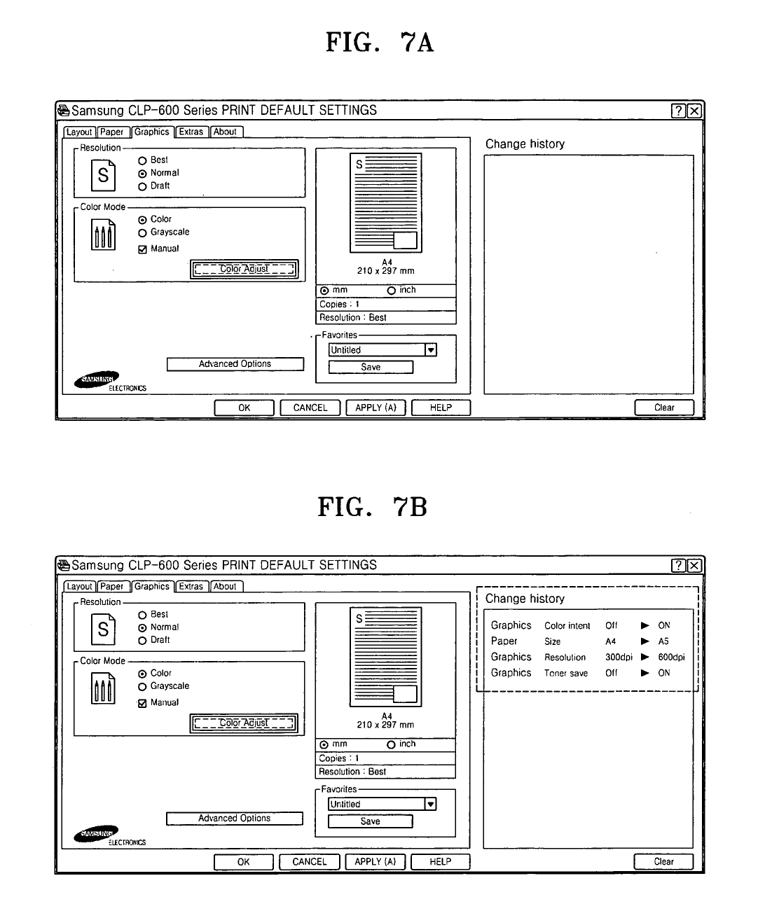

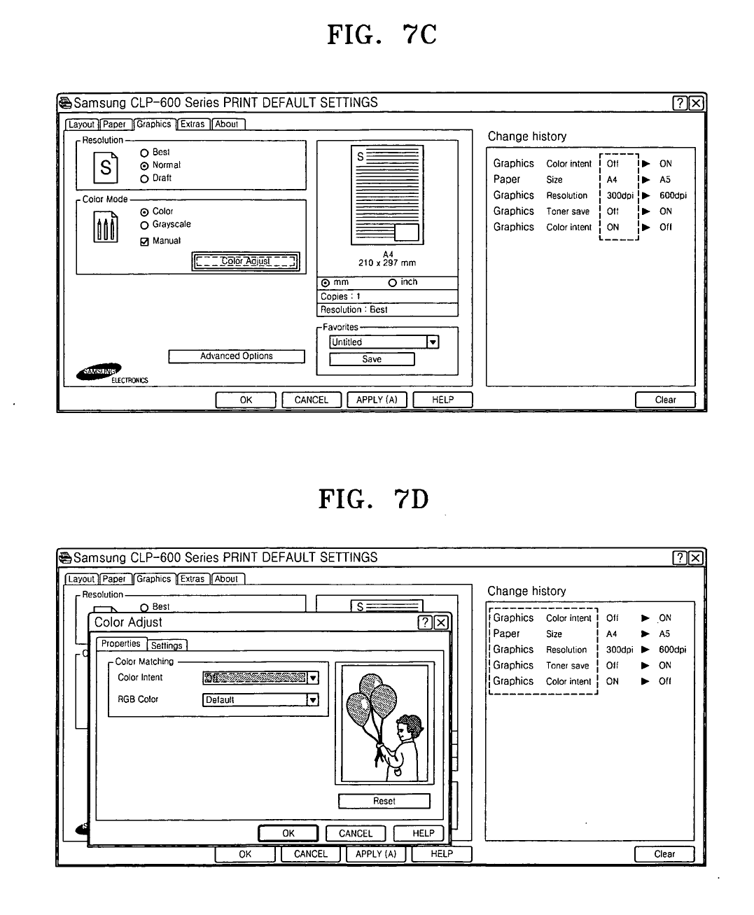

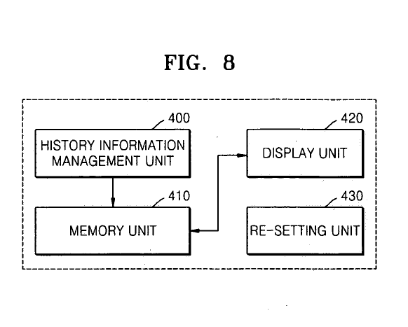

FIGS. 7A through 7D are examples of dialog windows for explaining the operations of the method of FIG. 5. FIG. 7A illustrates a dialog window where the user interface is activated, FIG. 7B illustrates a dialog window with change history information displayed, FIG. 7C illustrates the selection of certain configuration information from previous configuration information, and FIG. 7D illustrates current configuration information being re-set according to the previous configuration information selected in FIG. 7C. As described above, when the user wants to re-set current configuration information to previous configuration information, the user can re-set the configuration information with a simple operation according to the current exemplary embodiment. In contrast, information must be input one by one according to the prior art.

FIG. 8 is a block diagram of an apparatus for changing configuration information by using configuration information comparison according to another exemplary embodiment of the present invention. The user interface apparatus of FIG. 8 includes a history information management unit 400, a memory unit 410, a display unit 420, and a re-setting unit 430.

The history information management unit 400 manages change history information regarding configuration information changed in the past and outputs the management result to the memory unit 410. If the configuration information has been changed several times, the history information management unit 400 classifies information on each piece of the changed configuration information according to the type of change and manages the classified information as the change history information.

The memory unit 410 receives the change history information from the history information management unit 400 and stores the received change history information. The memory unit 410 outputs the change history information to the display unit 420 in response to a request of the display unit 420.

When a specified event occurs, the display unit 420 reads the change history information from the memory unit 410 and displays the read change history information on the display unit 420. The specified event may be, for example, an invocation of a user interface, a change of configuration information, or a request to display change history information.

The display unit 420 may display the change history in a dialog window such as that shown in FIG. 6, which was previously described.

If a user selects one of the displayed change history information, the re-setting unit 430 re-sets the configuration information to the selected change history information.

As described above, in a method and apparatus of changing configuration information by using configuration information comparison according to exemplary embodiments of the present invention, when changed values of complicated configuration information of an electronic device are confirmed or changed again, the changed values can be confirmed or changed again with a simple operation. That is, when configuration information of the electronic device is changed frequently, or when a plurality of users share the electronic device, to minimize the time and effort required to confirm the changed configuration information, a user interface allowing the users to easily confirm the changed configuration information and immediately change it if necessary is provided.

In addition, when it is necessary to re-set current configuration information to previous configuration information, the configuration information can be re-set with a simple operation, unlike the prior art. That is, when it is needed to change settings of a plurality of items or change a previously set value in a complicated user interface, a user can easily check recently changed values and modify the values if necessary without using unnecessary time and effort for checking and re-setting of the settings. Thus, time can be saved, and printing efficiency can be increased.

While the invention has been shown and described with reference to certain embodiments thereof, it will be understood by those skilled in the art that various changes in form and details may be made therein without departing from the spirit and scope of the invention as defined by the appended claims.

What is claimed is:

1. A method for setting configuration information, the method comprising:
(a) displaying a comparison of current configuration information and previous configuration information; and
(b) changing the current configuration information by referring to the comparison of current configuration information and previous configuration information.

2. The method of claim 1, wherein the previous configuration information is configuration information set within a previous setting time before the current configuration information was set.

3. The method of claim 1, wherein operation (a) comprises:
(a1) generating comparison configuration information reflecting a comparison of current configuration information and previous configuration information;
(a2) generating a detailed selectable list of the comparison configuration information; and
(a3) displaying a configuration information comparison window including the comparison configuration information and the detailed selectable list.

4. The method of claim 3, wherein operation (a) further comprises (a4) displaying a previous configuration information selection window to allow a user to select configuration information set within a previous setting time before the current configuration information was set,
wherein, after operation (a4), the comparison configuration information reflecting changes between previous configuration information selected in the previous configuration information selection window and the current configuration information is generated.

5. The method of claim 1, wherein in operation (a), the configuration information comparison window is displayed due to the operation of a display button, a check mark of a check box, or an automatic pop-up.

6. A computer readable recording medium storing a computer readable program for executing the method comprising:
(a) displaying a comparison of current configuration information and previous configuration information; and
(b) changing the current configuration information by referring to the comparison of current configuration information and previous configuration information.

7. An apparatus for setting configuration information, comprising:
a display unit that displays comparison configuration information reflecting a comparison between current configuration information and previous configuration information; and
a configuration information change unit that changes the current configuration information by referring to the comparison configuration information.

8. The apparatus of claim 7, wherein the previous configuration information is configuration information set before a previous setting time before the current configuration information was set.

9. The apparatus of claim 7, wherein the display unit comprises:
a comparison configuration information generator that generates the comparison configuration information;
a detailed list generator that generates a detailed selectable list of the comparison configuration information; and
a comparison window display unit that displays a configuration information comparison window including the comparison configuration information and the detailed selectable list.

10. The apparatus of claim 9, wherein the display unit further comprises a selection window display unit that displays a previous configuration information selection window to select configuration information set before a previous setting time before the current configuration information was set,
wherein the display unit generates comparison configuration information reflecting changes between previous configuration information selected by the selection window display unit and the current configuration information.

11. The apparatus of claim 7, wherein the display unit operates due to the operation of a display button, a check mark of a check box, or an automatic pop-up.

12. A method for managing configuration information, the method comprising:
managing change history information reflecting a history of changes to configuration information; and
displaying the change history information when an event occurs.

13. The method of claim 12, wherein the event comprises one of an invocation of a user interface, a change of configuration information, and a request to display change history information.

14. The method of claim 12, further comprising re-setting the configuration information to change history information selected from the displayed change history information.

15. An apparatus for setting configuration, the apparatus comprising:
a change history information management unit that manages change history information reflecting a history of changes to configuration information;
a memory unit that stores the change history information; and
a display unit that reads the change history information from the memory unit when an event occurs and displays the read change history information.

16. The apparatus of claim 15, further comprising a re-setting unit that re-sets configuration information to change history information selected from among the displayed change history information.

17. A method for setting configuration information, the method comprising:
(a) generating comparison configuration information reflecting a comparison of current configuration information and previous configuration information;
(b) generating a detailed selectable list of the comparison configuration information; and
(c) displaying a configuration information comparison window including the comparison configuration information and the detailed selectable list.

18. The method of claim 17, further comprising displaying a previous configuration information selection window to select configuration information set within a previous setting time before the current configuration information was set, wherein the previous configuration information is configuration information set within a previous setting time before the current configuration information was set.
